(19) United States
(12) Patent Application Publication
(10) Pub. No.: US 2026/0094460 A1
(43) Pub. Date: Apr. 2, 2026

(54) Machine Learning Systems and Methods for Improved Roof Condition Determination and Scoring from Aerial Imagery

(71) Applicant: Insurance Services Office, Inc., Jersey City, NJ (US)

(72) Inventors: Bryce Zachary Porter, Lehi, UT (US); Antonio Godino Cobo, South Jordan, UT (US); Francisco Miguel Rivas Montero, Móstoles, Madrid (ES); Jose David Aguilera Martin de los Santos, Matthews, NC (US)

(73) Assignee: Insurance Services Office, Inc., Jersey City, NJ (US)

(21) Appl. No.: 19/344,767

(22) Filed: Sep. 30, 2025

Related U.S. Application Data
(60) Provisional application No. 63/701,113, filed on Sep. 30, 2024.

(51) Int. Cl. G06V 20/70; G06T 7/00; G06V 20/10

(52) U.S. Cl. CPC G06V 20/70; G06T 7/0002; G06V 20/176; G06T 2207/10032; G06T 2207/20081; G06T 2207/20084

(57) ABSTRACT

Machine learning systems and methods for roof condition determination and scoring from aerial imagery. The system includes an inference module, a labeling module, and a training module. The inference module receives an aerial image of a roof and processes the aerial image using one or more trained neural network models to detect a condition of the roof depicted in the aerial image and to score the condition. The labeling module allows one or more agents to label training data for use in training the one or more neural network models, and the training module trains the one or more neural network models using the labels generated by the labeling module. The one or more neural network models includes a multi-layer neural network model including a backbone network layer and a fully-connected convolutional layer.

### BACKGROUND

### Related Applications

This application claims priority to U.S. Provisional Application Ser. No. 63/701,113 filed on Sep. 30, 2024, the entire disclosure of which is expressly incorporated herein by reference.

### Technical Field

The present disclosure relates generally to the field of machine learning. More specifically, the present disclosure relates to machine learning systems and methods for improved roof condition determination and scoring from aerial imagery.

### RELATED ART

In the insurance claims processing field, the ability to rapidly determine the condition of a roof from aerial imagery is of significant importance in properly handling roof and/or structure damage insurance claims. Insurance underwriters frequently use knowledge about the inherent risk of a given property to make policy decisions. However, this process is often time-consuming and prone to errors.

The continually-developing field of machine learning can leveraged to significantly improve the process of determining roof condition from aerial imagery. In particular, machine learning can be adapted to evaluate the ability of various roof materials to properly shed water and to protect the underlying structural materials of a building, as well as to estimate the age of a roof. Such information can provide a useful summary of the general state of the roof presented in an image, thereby significantly speeding up the processing of insurance claims and the accuracy of such claims. Indeed, in the case of a catastrophic weather event, a single roof condition score that is rapidly and accurately generated by machine learning techniques may be used to quickly evaluate the destruction caused by the catastrophe and identify the areas that were most impacted.

Accordingly, what would be desirable, but have not yet been provided, are machine learning systems and methods for improved roof condition determination and scoring from aerial imagery which address the foregoing and other needs.

### SUMMARY

The present disclosure relates to machine learning systems and methods for roof condition determination and scoring from aerial imagery. The system includes an inference module, a labeling module, and a training module. The inference module receives an aerial image of a roof and processes the aerial image using one or more trained neural network models to detect a condition of the roof depicted in the aerial image and to score the condition. The labeling module allows one or more agents to label training data for use in training the one or more neural network models, and the training module trains the one or more neural network models using the labels generated by the labeling module. The one or more neural network models includes a multi-layer neural network model including a backbone network layer and a fully-connected convolutional layer.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating the machine learning system of the present invention;

FIG. 2 diagram illustrating processing steps carried out by the systems and methods of the present disclosure for roof condition detection and scoring from aerial imagery;

FIG. 3 is a diagram illustrating a neural network model implemented by the systems and methods of the present disclosure;

FIG. 4 illustrates a roof condition score and report generated by the systems and methods of the present disclosure;

FIG. 5 is a diagram illustrating processing steps carried out by the systems and methods of the present disclosure for consensus labeling of training data; and

FIG. 6 is a flowchart illustrating processing steps carried out by the systems and methods of the present disclosure for post-processing of training labels.

### DETAILED DESCRIPTION

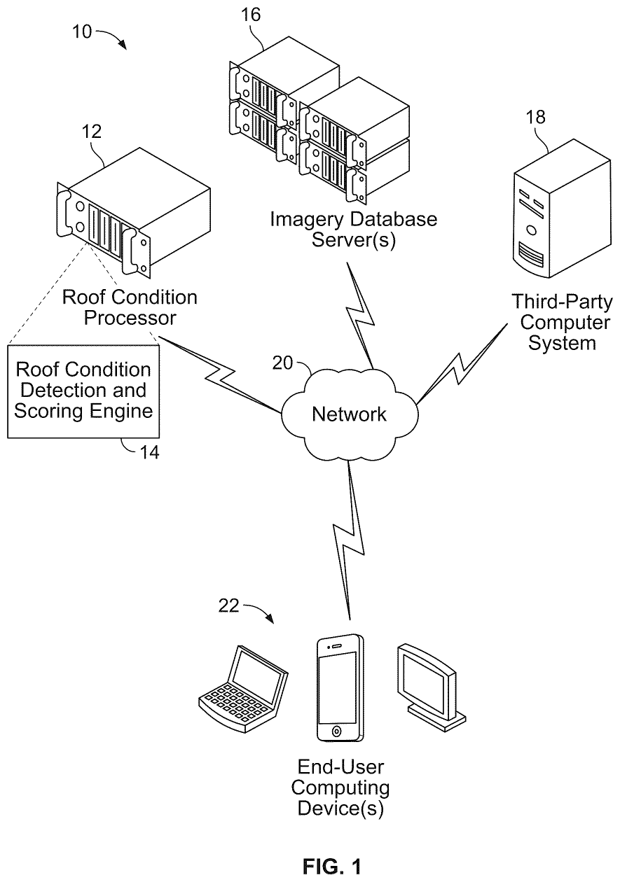

The present disclosure relates to machine learning systems and methods for roof condition detection and scoring from aerial imagery, as set forth in detail below in connection with FIGS. 1-6.

FIG. 1 is a diagram, indicated generally at 10, illustrating the machine learning system of the present invention. The system 10 includes a roof condition processor (computer system) 12 that executes a roof condition detection and scoring engine 14 to detect and score various roof conditions from aerial images of structures. The processor 12 can obtain the aerial images from one or more imagery database servers 16, which could be in communication with the processor 12 via a communications network 20. Additionally, the processor 12 could communicate with one or more third-party computer systems 18 (e.g., an insurer's computer system or a computer system of another entity) and/or one or more end-user computing devices 22 via the communications network 20.

The platform 12 processes aerial images using customized machine-learning software modules which are trained to detect various roof conditions from aerial images and to score such conditions. The aerial images could include, but are not limited to, photographic aerial images, light detection and ranging (LiDAR) images, digitized images, or other suitable types of images. The platform 12 could include any suitable computing platform including, but not limited to, a server, a cloud computing platform, a personal computer, a mobile device (e.g., smart phone), or any other suitable computing platform. The engine 14 could be coded in any suitable high- or low-level computing language, including, but not limited to, C, C++, C#, Java, Python, or any other suitable programming language. Moreover, the end-user computing devices 22 could include, but are not limited to, personal computer, mobile devices (e.g., smart phones), laptop computers, or any other suitable computing devices.

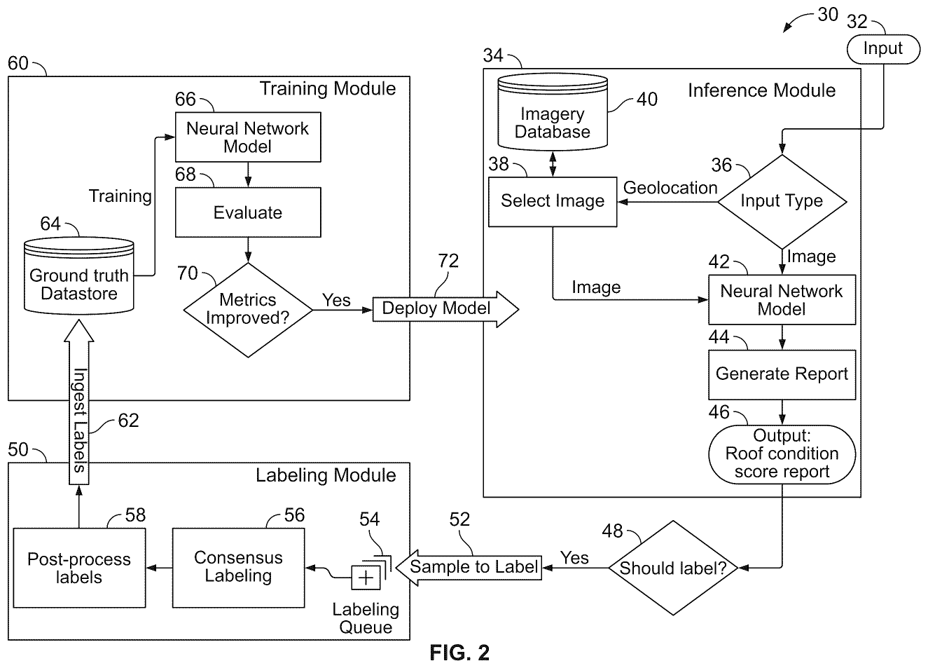

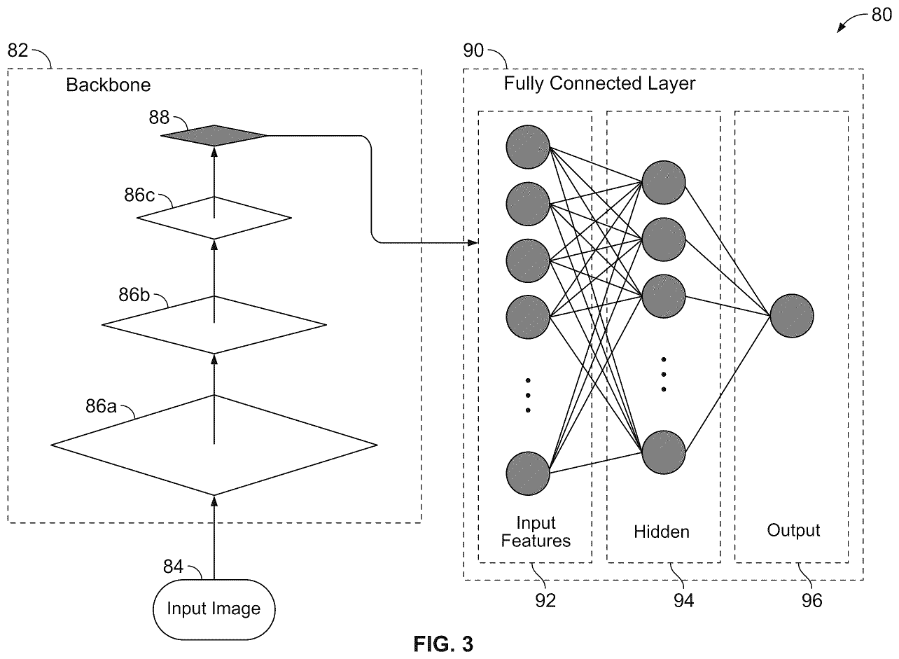

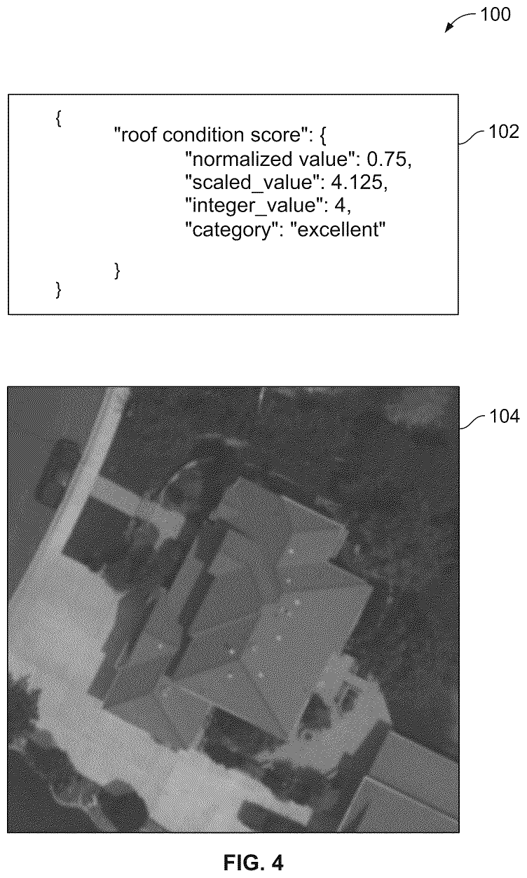

FIG. 2 diagram, indicated generally at 30, illustrating processing steps carried out by the systems and methods of the present disclosure for roof condition detection and scoring from aerial imagery. An inference software module 34 processes an input 32 to the module 34. The inference module 34 handles input requests to the system and produces a final report which may be in test or visual formats (such as a Javascript Object Notation (JSON) message, or an image with text overlaid on the image). First, in step 36, the module 34 determines whether the type of the input 32 is an image or a geolocation specified by a user (e.g., a mailing address, latitude/longitude coordinates, etc.). If the type is a geolocation, step 38 occurs, wherein the system selects an aerial image corresponding to the geolocation from an imagery database 40 (which could be stored on and retrieved from the imagery database server(s) 16 of FIG. 1). In step 42, the module 34 processes the image using a neural network model, discussed in more detail below in connection with FIG. 3, which detects one or more conditions of a roof depicted in the image and scores the roof condition. In step 44, the system generates a report indicating the detected roof condition and score, as discussed in greater detail below in connection with FIG. 4. In step 46, the system outputs the roof condition score report to, e.g., one or more of the end-user computing devices 22 and/or the third-party computer system 18 of FIG. 1.

Given a property of interest, identified by an address, geospatial coordinates, or some other globally-identifiable descriptor, the inference module 30 produces a report that indicates the condition of all roofs present at the property's location. As noted above, the input may be an image itself, and preferably is an image of a single roof structure. Also, the input image is preferably a top-down image where the majority of the roof is visible and is the central focus of the image. The user can select the desired property by inputting an address, latitude/longitude coordinate, a Universal Transverse Mercator (UTM) polygon, or other indicator. The inference module 30 loads the appropriate aerial imagery, satellite imagery, unmanned aerial vehicle (UAV) imagery, etc., corresponding to the desired property. A single vertical or oblique view of the property can be processed by the system, if desired. Also, the image can be orthorectified or otherwise modified, if needed or desired. It is beneficial when first collecting the dataset that the images to be labeled represent a wide variety of roof materials and roof conditions. This may help improve the system's ability to generalize to all the different scenarios that may be present in the imagery. The system will continue to collect data as more geolocations are requested and labeling continues over time. The labeling module 50, discussed below, uses versioning to keep track of different sets of data including the sources and distribution of labeled roof condition scores so that the training module can use this information to balance the input data during training.

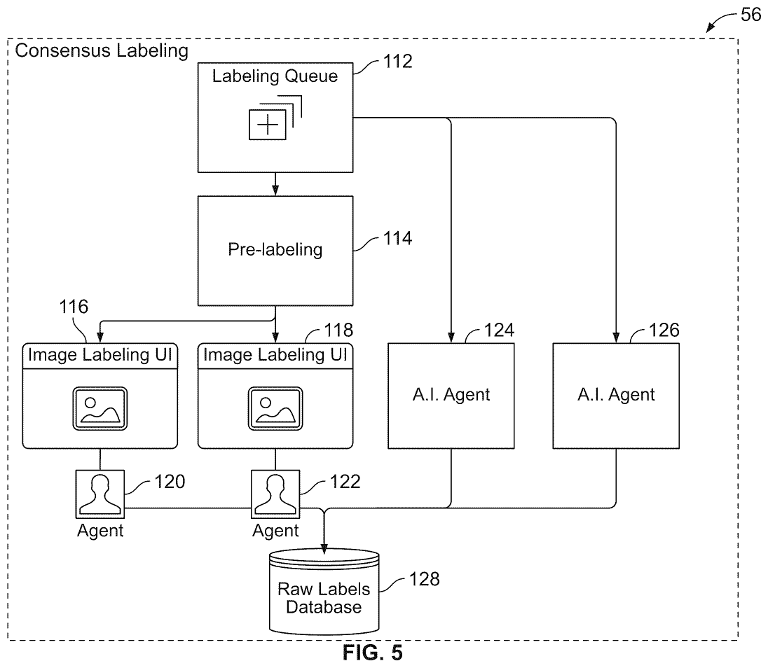

In step 48, a determination is made as to whether the neural network model should be further trained using the image and one or more labels applied to the image (e.g., in the event that the module 34 incorrectly or inaccurately detects roof conditions). If so, a sample 52 to be labeled (which could be the entire image or a portion of the image) is processed by labeling module 50 and stored in a labeling queue 54. The labeling module 50 receives periodic input from the inference module 30 when the system determines that new data requires labeling. For example, the system may randomly select to review and label a predetermined portion (e.g., 10%) of the outputs from the inference module 30. The labeling module 50 could receive a random selection, and/or a software application with a user interface could be utilized to visually review images and to assign ground truth labels to the images using consensus labeling techniques. The queue 54 is then processed in step 56 to perform consensus labeling of the images in the queue 54, as discussed in greater detail in FIG. 5.

Next, the training module 60 ingests the labels in step 62 and stores them in a ground truth datastore 64. The datastore 64 is then used in step 66 to train the neural network model, and in step 68, the results of training are evaluated by the training module 60. In step 70, a determination is made as to whether performance metrics of the neural network model. If so, the trained module is deployed in step 72 in the inference module 34, for future use by the module 34. The training module 60 can track different versions of training datasets, and can automatically start training processes when enough new data is available for training. Additionally, the training module 60 can evaluate any newly-trained neural network models against a variety of metrics. If a new neural network model outperforms previous versions of the model, then that model can automatically be deployed into the inference model 30. With this cycle of inference, labeling, and training, the system of the present disclosure is able to automatically take feedback and use such feedback to improve the system over time. Additionally, it is noted that the various modules discussed in connection with FIG. 2 could be utilized for detecting and scoring other property features that could be generated by neural network models from aerial imagery, including, but not limited to, roof material, roof condition segmentation, solar panel segmentation, chimney detection, pools, trampolines, or other property feature detections.

The system of the present disclosure can produce a floating point score between 0 and 1 or any other desirable range, from worst to best. For example, on a scale from 0 to 1, 0 could indicate a non-functional roof, and 1 could indicate a roof with no perceived defects. A real number value could be generated and scaled and discretized to create an easy-to-interpret categorization of the condition of the roof. For example, the system could scale and discretize the 0 to 1 floating point value to produce an integer value between 1 and 5.

The training module 60 of FIG. 2 is responsible for tracking training experiments and evaluating different versions of the neural network model to find the best possible version for deployment. The training module contains 60 a datastore that stores the ground truth samples created by the labeling module and it also tracks different versions of the training, validation and hold-out test datasets used during the training experiments. The datastore may decide to ingest a large number of samples before adding those samples to either train, validation or test datasets and creating a new version. If a new version of the hold-out test dataset is created then older versions of the neural network model will be tested against the hold-out test dataset to allow for equal comparisons between old and new neural network model versions.

When the datastore generates a new version of the training dataset with new samples that have not been used in training, the system automatically starts a one or more new training experiments. For each training experiment the system selects a neural network model architecture (for example, MobileNetV3) and the latest dataset version and starts a training job in which the neural network model is trained. The network is trained using a loss function that is appropriate for comparing the ground truth labels to the predicted output. For example, if the ground truth labels are floating point values then the loss function will compare the error between two numerical values (such as the L1 loss or a mean squared error loss). The training process is stopped when the network has reached the desired number of epochs trained or any other stopping criteria is met (such as no improvements to the metrics in an arbitrary number of epochs). After a new model is trained, it is evaluated using metrics appropriate to the task. There may be a multiplicity of metrics used to evaluate the model. Some such metrics may include but are not limited to, accuracy, F1 score, MAE (mean absolute error), and RMSE (root mean squared error). Other performance metrics that may be included are the inference time required to execute on a central processing unit (CPU) or any other accelerated device (graphics processing unit (GPU), tensor processing unit (TPU), etc.), the model size on disk and model load times. If the new model is found to perform better in the core metrics evaluated than the previous models, then the model is deployed to the inference module to be used in generating reports for users.

FIG. 3 is a diagram, indicated generally at 80, illustrating a neural network model implemented by the systems and methods of the present disclosure. This model is a convolutional neural network and could be utilized in connection with the neural network models discussed above in connection with FIG. 2. Specifically, the model includes a backbone layer 82 which processes an input image 84, and a fully-connected layer 90 that processes output of the backbone layer 82. The backbone layer 82 includes neural network layers 86a-86c to process the input image 84 and to extract and encode features into a feature vector 88, which is then processed by the fully-connected layer 90. The fully-connected layer 90 includes fully-connected network layers 92-96 that process the feature vector 88 by applying a linear transformation for the feature vector and producing a single value as output, which is the roof condition score expressed as a floating point number. Additionally, it is noted that a function could be utilized which takes the value from the fully-connected layer 90 and bounds it to a desired output range (for example, bounding the value between 0 and 1.

FIG. 4 illustrates a roof condition score and report 100 generated by the systems and methods of the present disclosure. The report 100 includes a roof condition score section 102 (which indicates the roof condition score calculated by the system) and, optionally, an image 104 depicting the roof being scored. The roof condition score section 102 could indicate the roof condition score as a normalized value, a scaled value, and/or an integer value, and it could also include a human-readable category (such as “excellent” for a roof in excellent condition, “poor,” “good,” etc.).

After returning the report 100, the system could take a sample of requests made and send them to the labeling module 50 of FIG. 2 for review and labeling. This sampling may be done by random sample, or by asking for user feedback via an user interface. For example, the system may decide to randomly select 10% of unique requests to send to the labeling queue for review and labeling. The user interface may ask the user if they agree with the provided report based on the image provided. If the user agrees or disagrees with the report, it may be automatically sent to the labeling queue 54 in the labeling module 50 for future labeling.

FIG. 5 is a diagram illustrating processing step 56 of FIG. 2 in greater detail, relating to consensus labeling of training data. The dataset is labeled using software and labeling criteria to rate each roof with a score between two values (the smallest value being lowest quality roof and the highest value being the highest quality roof). In step 112, the system receives a plurality of labels in a labeling queue. Next, in step 114, the system performs pre-labeling of the labels in the queue, using the current version of the neural network model. In this case, the example is supplied from the inference module 30, and the sample may already include one or more labels. In steps 116-118, manual labeling can be performed by human agents 120-122 using a suitable user interface. The agents 120-122 can view an image and assign a roof condition score for each image (or group of images) displayed in the user interface. Additionally, in steps 124-126, one or more artificial intelligence (AI) agents can perform labeling of the training data.

Consensus labeling techniques can be utilized to provide a ground truth label that is not biased to a single agent opinion. More specifically, using these techniques, the sample is sent to multiple labelers independently so that a multiplicity of independent labels are collected. The system can use the consensus labels to automatically find and discard samples where the consensus is not strong, and it can also resolve any consensus labels into a single ground truth value that can be used by the training module 60 of FIG. 2. The assigned label may be a continuous value, discrete value or categorical. It is also valuable to have multiple independent labeling agents label each example in the dataset. As noted above, the labeling agents may be human agents with an interface for labeling or may be multiple different AI agents (for example, a previous version of the neural network model may be used for annotation). With multiple independent labels, it is possible to use consensus to find and remove outliers or to take an average label as the ground truth label for the dataset. For example, if a set of five labelers each labels a single aerial image of a roof with a score of 1 to 5 (1 for worst condition and 5 for perfect condition), it would be possible to consider the mean as the ground truth value for that roof condition. This helps to eliminate bias in labeling, and misunderstandings between labelers on the labeling guidelines provided. Other averages such as the median, or mode may also be used to create a single ground truth condition score from consensus labeling practices. The results of all labeling are collected and stored in a raw labels database 128.

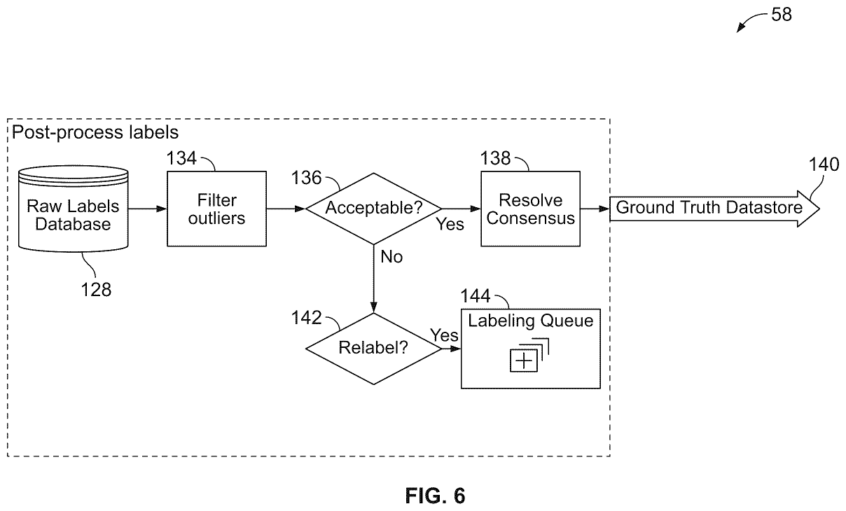

FIG. 6 is a flowchart illustrating processing steps illustrating step 58 of FIG. 2 in greater detail, relating to post-processing of labels. In step 134, the system accesses the raw labels database 128 of FIG. 5, retrieves raw labels, an filters outliers from the labels. In step 136, a determination is made as to whether the filtered labels are acceptable. If so, step 138 occurs, wherein the system resolves a label consensus, and then in step 140, a ground truth datastore is established. Otherwise, step 142 occurs, wherein a determination is made as to whether to relabel the raw labels. If so, the raw labels are stored in the labeling queue in step 144.

The post-processing phase discussed in connection with FIG. 6 is responsible for filtering out labels that are likely to be problematic and also resolving the consensus labels down into a single label that can be ingested and used as part of the training dataset. Identifying samples that are difficult or potentially incorrectly labeled is a first step in post-processing. Consensus labeling can be used to automatically identify problematic samples that either need to be rejected entirely or sent for additional review. This can be done by looking for outliers in the distribution of labels (for example, if the system calculates a sample having a median score of 4.0 (excellent quality roof score) but there are two labelers that rated that sample as a 2.0 (significantly worse quality roof score)). The system can flag that sample as having a significant discrepancy and automatically reject that sample because there is not sufficient agreement on what the label should be. When a sample is rejected it can either be discarded entirely or it can be sent for expert review to manually resolve the consensus issue.

During the training each sample needs to have one ground truth label associated with the sample. The system needs to resolve the consensus labels to a single ground truth label per sample. This can be done by using the mean, median or mode score. It may also be done by taking a weighted average of the scores based on user labeling experience or training level (for example, the labels created by an expert annotator are given more weight than those of a novice annotator). After resolving the consensus labels to a single ground truth label the labels may be stored in the final label database. The final label database is used to store the final ground truth labels as well as different versions of the training, validation and testing datasets.

Having thus described the systems and methods in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure. What is desired to be protected by Letters Patent is set forth in the following claims.

What is claimed is:

1. A machine learning system for roof condition determination and scoring from aerial imagery, comprising:
a roof condition processor receiving at least one aerial image of a roof; and
a roof condition detection and scoring software engine executed by the roof condition processor, the engine including:
an inference module that processes the at least one aerial image using one or more trained neural network models to detect a condition of the roof depicted in the at least one aerial image and scoring the condition,
a labeling module allowing one or more agents to label training data for use in training the one or more neural network models, and
a training module training the one or more neural network models using a plurality of labels generated by the labeling module.

2. The system of claim 1, wherein the at least one aerial image comprises at least one of a photographic aerial image, a light detection and ranging (LiDAR) image, or a digitized image.

3. The system of claim 1, wherein the inference module generates a report including a roof condition score indicating a condition of the roof.

4. The system of claim 3, wherein the report includes an image depicting the roof being scored.

5. The system of claim 3, wherein the report is transmitted as a Javascript Object Notation (JSON) message.

6. The system of claim 1, wherein the labeling module performs consensus labeling of the at least one aerial image.

7. The system of claim 1, wherein the at least one trained neural network comprises a backbone layer which processes the at least one aerial image and a fully-connected layer that processes output of the backbone layer.

8. The system of claim 7, wherein the backbone layer comprises a plurality of neural network layers that extract and encode features into a feature vector.

9. The system of claim 8, wherein the fully-connected layer comprises a plurality of fully-connected network layers that process the feature vector to produce a roof condition score.

10. The system of claim 9, wherein the fully-connected network layers apply a linear transformation to the feature vector to produce the roof condition score.

11. A machine learning method for roof condition determination and scoring from aerial imagery, comprising:
receiving by a roof condition processor at least one aerial image of a roof;
processing the at least one aerial image using one or more trained neural network models to detect a condition of the roof depicted in the at least one aerial image and scoring the condition,
allowing one or more agents to label training data for use in training the one or more neural network models, and
training the one or more neural network models using a plurality of labels generated by the labeling module.

12. The method of claim 11, wherein the at least one aerial image comprises at least one of a photographic aerial image, a light detection and ranging (LiDAR) image, or a digitized image.

13. The method of claim 11, further comprising generating a report including a roof condition score indicating a condition of the roof.

14. The method of claim 13, wherein the report includes an image depicting the roof being scored.

15. The method of claim 13, further comprising transmitting the report as a Javascript Object Notation (JSON) message.

16. The method of claim 1, further comprising performing consensus labeling of the at least one aerial image.

17. The method of claim 11, wherein the at least one trained neural network comprises a backbone layer which processes the at least one aerial image and a fully-connected layer that processes output of the backbone layer.

18. The method of claim 17, wherein the backbone layer comprises a plurality of neural network layers that extract and encode features into a feature vector.

19. The method of claim 18, wherein the fully-connected layer comprises a plurality of fully-connected network layers that process the feature vector to produce a roof condition score.

20. The method of claim 19, wherein the fully-connected network layers apply a linear transformation to the feature vector to produce the roof condition score.
